(19) United States
(12) Patent Application Publication
(10) Pub. No.: US 2026/0105088 A1
(43) Pub. Date: Apr. 16, 2026

(54) AUGMENTED GENERATIVE LANGUAGE MODEL-BASED INFERENCE SYSTEM AND METHOD

(71) Applicant: ELECTRONICS AND TELECOMMUNICATIONS RESEARCH INSTITUTE, Daejeon (KR)

(72) Inventor: Jong Hun Shin, Daejeon (KR)

(21) Appl. No.: 19/357,814

(22) Filed: Oct. 14, 2025

(30) Foreign Application Priority Data
Oct. 15, 2024 (KR) 10-2024-0140296

(51) Int. Cl. G06F 16/3332; G06F 16/35

(52) U.S. Cl. CPC G06F 16/3338; G06F 16/35

(57) ABSTRACT

Disclosed are an augmented generative language model-based inference system and method. The augmented generative language model-based inference method includes (a) performing pre-diagnosis of uncertainty of a generative language model, (b) generating a prompt template to train the generative language model, and (c) performing inference of returning confidence along with a response when a user query is input using the generative language model.

### CROSS-REFERENCE TO RELATED APPLICATION

The present application claims priority to and the benefit of Korean Patent Application No. 10-2024-0140296, filed on Oct. 15, 2024, in the Korean Intellectual Property Office, the entire disclosure of which is incorporated herein by reference.

### BACKGROUND

### 1. Technical Field

The present disclosure relates to an augmented generative language model-based inference system and method, and more particularly to an augmented generative language model-based inference system and method, to which uncertainty quantification is added.

### 2. Description of Related Art

According to conventional technology, a classification model intended to output confidence in its own answer through uncertainty quantification and uncertainty estimation. Deep neural network-based machine learning has adopted a method of utilizing a probability distribution as a kind of confidence in relation to output for a classification model. According to the conventional technology, a problem arises in that a generative model needs to sample vocabulary tokens to assemble its final response, it is impossible to determine the reliability of the entire response from the average or cumulative combined value of a calibrated probability distribution over a single token, and it is difficult to simply employ a token-level probability distribution as a confidence measure.

In addition, conventional commercialized Large Language Model (LLM) Application Programming Interface (API) is problematic in that the probability distribution of each token cannot be obtained, thus making it difficult to estimate confidence or uncertainty at a token level.

### SUMMARY

Embodiments of the present disclosure are directed to providing an inference system and method that are capable of obtaining, with respect to results generated by an augmented generative language model, quantitative representations that enable uncertainty or confidence to be compared under various criteria, together with the results.

The present disclosure relates to an augmented generative language model-based inference system and method, and more particularly to an augmented generative language model-based inference system and method, to which uncertainty quantification is added.

An augmented generative language model-based inference method according to the present disclosure includes (a) performing pre-diagnosis of uncertainty of a generative language model, (b) generating a prompt template to train the generative language model, and (c) performing inference of returning confidence along with a response when a user query is input using the generative language model.

(a) may include diagnosing characteristics of the generative language model in advance using a diagnostic dataset, and classifying results of diagnosis.

The diagnostic dataset may include diagnosis datasets for application domain classification and for query task type classification.

Diagnostic data in the diagnostic dataset may include knowledge-augmented data including context having a correct answer, knowledge-augmented data composed of contexts unrelated to the correct answer, knowledge-augmented data composed of contexts contradicting the correct answer, a query, the correct answer, and type definition metadata.

(a) may include (a-1) determining whether combination with augmented context is to be performed, (a-2) determining whether combination with knowledge-augmented data is to be performed, (a-3) performing inference using the generative language model, (a-4) performing aggregation and quantification on uncertainty, (a-5) checking whether remaining diagnostic data is present, and (a-6) calculating uncertainty information for an input-result pair and each augmented context.

When it is determined in (a-1) that combination with the augmented context is to be performed, the augmented context may be combined with an original query in (a-2).

(a-3) may include extracting sampled candidates.

(a-4) may include quantifying variability in a difference in actual meaning between sampled candidates and the correct answer.

The augmented generative language model-based inference method may further include, when it is determined in (a-5) that remaining diagnostic data is present, returning to (a-1) of performing processing on a remaining dataset.

When it is determined in (a-5) that remaining diagnostic data is not present, (a-6) may include clustering groups sharing an identical query, obtaining an average and variance of uncertainty for an input-result pair and each augmented context, and then calculating and storing baselines for respective environments.

(b) may include performing fine-tuning on the generative language model in an environment in which access to weight information of the generative language model is enabled to allow additional training.

(c) may include (c-1) receiving query text of a user, (c-2) performing domain and task classification for input, (c-3) completing a template using results of the classification and a query, (c-4) generating an input configuration, and (c-5) performing inference using the generative language model and a back-off confidence model.

An augmented generative language model-based inference system according to the present disclosure may include a memory configured to store a program for performing pre-diagnosis of uncertainty of a generative language model, generating a prompt template to train the generative language model, and returning confidence along with a response when a user query is input using the generative language model, and a processor configured to execute the program.

The processor may be configured to diagnose characteristics of the generative language model in advance using a diagnostic dataset and classify results of the diagnosis.

The processor may be configured to determine whether combination with augmented context is to be performed, determine whether combination with knowledge-augmented data is to be performed, perform inference using the generative language model, perform aggregation and quantification on uncertainty, check whether remaining diagnostic data is present, and calculate uncertainty information for an input-result pair and each augmented context.

The processor may be configured to, when it is determined that combination with the augmented context is to be performed, combine the augmented context with an original query.

The processor may be configured to extract sampled candidates and quantify variability in a difference in actual meaning between the sampled candidates and the correct answer.

The processor may be configured to, when it is determined that remaining diagnostic data is not present, cluster groups sharing an identical query, obtain an average and variance of uncertainty for an input-result pair and each augmented context, and then calculate and store baselines for respective environments.

The processor may be configured to receive query text of a user, perform domain and task classification for input, complete a template using results of the classification and a query, generate an input configuration, and perform inference using the generative language model and a back-off confidence model.

According to the present disclosure, there is an advantage in that the characteristics of a generative language model being used are determined without any constraints on the generative language model, and then the uncertainty of a response returned in the stage of utilizing the corresponding model is returned to a user, thus assisting the user in making correct decisions.

According to the present disclosure, there is an advantage in that it is possible to provide a more reliable inference service by configuring a system that acquires indirect confidence in a knowledge-augmented generative language model based on retrieval or the like, and returns the result of an alternative back-off model when the result of inference does not meet a criterion through confidence evaluation for the inference result.

The effects of the present disclosure are not limited to those mentioned above, and other effects not explicitly stated will be clearly understood by those skilled in the art from the following description.

### BRIEF DESCRIPTION OF THE DRAWINGS

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings:

FIG. 1 illustrates an augmented generative language model-based inference system according to an embodiment of the present disclosure.

FIG. 2 illustrates an augmented generative language model-based inference method according to an embodiment of the present disclosure.

FIG. 3 illustrates a detailed process of a pre-diagnosis step according to an embodiment of the present disclosure.

FIG. 4 illustrates an inference step according to an embodiment of the present disclosure.

FIG. 5 is a block diagram illustrating a computer system for implementing a method according to an embodiment of the present disclosure.

### DETAILED DESCRIPTION

The above object and other objects, advantages and features of the present disclosure, and methods for achieving the same will be cleared with reference to embodiments described later in detail together with the accompanying drawings.

However, the present disclosure is not limited to the embodiments disclosed below, and may be implemented in various other forms. The following embodiments are merely provided to enable those skilled in the art to easily understand the objects, configuration, and effects of the present disclosure. The scope of the present disclosure should be defined by the description of the accompanying claims.

Meanwhile, the terminology used in the present specification is intended solely for the purpose of describing embodiments and is not intended to limit the scope of the present disclosure. In the present specification, the singular forms also include the plural forms unless the context clearly indicates otherwise. The terms “comprises” and/or “comprising” used in the specification are merely intended to indicate that components, steps, operations, and/or elements described below are present, and do not exclude the presence or addition of one or more other components, steps, operations, and/or elements.

Hereinafter, the background in which the present disclosure is proposed will be described, and then embodiments of the present disclosure will be described.

The latest commercial language model (e.g., OpenAI's GPT-4 or Google Gemini) demonstrates potential for collaboration with humans in critical environments, thanks to outstanding performance and various application potential abilities thereof. The latest commercial language model returns best-effort results by relying heavily on training information it has memorized and given input conditions (i.e., in an overconfident state). Even when a small part of input is modified, the result may change significantly. Nevertheless, it is impossible to identify the necessary and sufficient conditions of each piece of information given during a process of relying on input conditions and training information, thus making it difficult to stably return the uncertainty and confidence of inference. In addition, a problem arises in that, as retrieval/association results that are unsuitable or irrelevant to actual requirements (user input) are linked between inference processes through Retrieval Augmented Generation (RAG)-based generative language model, inference performance decreases.

In the conventional technology proposed to solve these problems, retrieved information is compared with the original input to determine whether the retrieved information is associated with, is contradictory to, or unrelated to the original input through a machine-trained Natural Language Inference (NLI) model (i.e., a classification model that determines whether two contexts composed of a given premise and a hypothesis are in entailment, neutral, or contradiction relation to each other). When it is determined the retrieved information is associated with the original input, a filtering method or a back-off mechanism is employed, wherein the back-off mechanism is a method of performing inference using a pure generative language model without retrieval in the case where a retrieved result does not meet given conditions.

In another conventional technology, data is generated by mixing directly related or unrelated retrieval results with small-scale user input data and appropriate responses suitable for the user input data (in the case where corresponding data is combined with unrelated or unsuitable retrieval data, supervised learning such as “I don't know” is performed), thus enabling a method of building a robust model against unsuitable or unrelated retrieval results to cope with the problems.

According to the above-described conventional technology, a problem arises in that generation quality significantly varies depending on excessive filtering or the performance of the NLI classification model, and parameter update occurring in a supervised learning stage suppresses the appearance of inherent knowledge contained in an existing model, thus resulting in the negative effect of increasing over-dependency on external knowledge (input).

More fundamentally, in the case where the foregoing methods do not properly function and retrieved content is adopted even when the retrieved content is incorrect, the user still heavily relies on such content. Nevertheless, the model cannot inform the user of this situation, thus preventing the user from critically evaluating the result.

When a collaboration process between humans is considered, each individual produces the best results while iteratively exchanging responses within his or her knowledge section, along with the level of confidence in the responses, with others, instead of always presenting the best answer.

A generative language model referred to as a Large Language Model (LLM) tends to be overly confident in information it knows or in information input thereto and to always output the best answers as the results. However, the LLM is excessively affected by human input or retrieved results, and then easily swayed.

Recent language models output responses with contextual cues being included in the responses through a response alignment process, wherein the contextual cues indicate that the responses may have ambiguity or vulnerability in various opinions. However, this approach serves merely as a warning to prevent the language models from having blind faith in persons, regardless of the actual inference capability of the model.

According to the conventional technology, as an approach called uncertainty quantification and uncertainty estimation, there is an attempt to allow a classification model to output confidence in its own answers. In deep neural network-based machine learning called deep learning, output for a classification model may be represented by a probability distribution in which the sum of probabilities of all classification targets is 1, and thus a method of utilizing this probability distribution as a kind of confidence measure has been adopted. This method centers on aligning the probability distribution with confidence intervals, and this process is referred to as calibration or conformal training.

A generative model, in order to construct the final response, needs to sample anywhere from tens to thousands of vocabulary tokens. Therefore, the reliability of all responses cannot be assessed based on the average or cumulatively combined value of the calibrated probability distribution for a single token. Moreover, recent generative models do not generate responses by simply continuously selecting a single token with the highest probability in a response generation process. Instead, to enhance diversity and response expression performance, sampling is probabilistically performed within a possible probability distribution. As a result, a problem arises in that it is difficult to simply utilize a probability distribution at a token level as a kind of confidence measure.

Further, in commercialized LLM API service such as current GPT-4, Claude, or Gemini, it is impossible to acquire the probability distribution of each token. As a result, a problem arises in that calibration is impossible in an environment in which a probability distribution itself cannot be provided, thus making it difficult to estimate confidence or uncertainty at a token level.

Recently, in order to grant abstention ability to a generative model such as by allowing the generative model to directly generate its own confidence, a method of providing an instruction to answer “I don't know” when uncertain has been proposed. However, this capability tends to emerge only in very large-scale models, and the self-generated confidence also tends to be significantly overestimated, thus making it difficult to employ the generative model alone.

The present disclosure is proposed to solve the above-described problems and is intended to provide an indicator or auxiliary means capable of evaluating the confidence of a generative language model's responses, in terms of how much the generative language model relies on input or on its memory (i.e., learned parameters) when the generative language model generates its own responses, thus allowing the indicator or the auxiliary means to be a criterion based on which humans accept the results. Accordingly, the present disclosure is not intended for a binary use of either accepting or rejecting the results generated by the generative language model, and is intended to support the generative language model so that the humans utilize the results generated by the generative language model in a wide spectrum such as human opinion aggregation in such a way as to filter generated results (i.e. partially refer only to a portion that is not known) or to refer to the same at the level of checking possibility.

According to an embodiment of the present disclosure, there is proposed a technique for a generative language model that produces subsequent output based on conditional probability distributions over input and generates outputs meeting various conditions and cases. More specifically, the present disclosure presents an inference system that returns enhanced inference results for diverse inputs by either purely retrieving from user-input information or by augmenting the user input with additional knowledge and information, such as from a knowledge graph or knowledge memory.

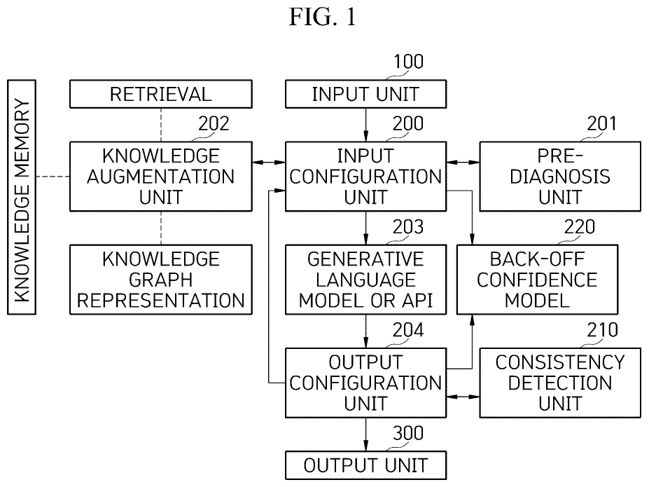

FIG. 1 illustrates an augmented generative language model-based inference system according to an embodiment of the present disclosure.

In the description of embodiments of the present disclosure, terms such as “˜unit,” “˜device,” or “˜module” refer to components that perform at least one function or operation, and may be implemented with hardware, software, or a combination thereof with a machine learning model optimized through a machine learning method.

The augmented generative language model-based inference system according to the embodiment of the present disclosure may include an input unit 100, an input configuration unit 200, a knowledge augmentation unit 202, a generative language model or API 203, an output configuration unit 204, an output unit 300 that outputs generative results including quantified uncertainty or confidence representation, a pre-diagnosis unit 201, and a consistency detection unit 210. Optionally, the augmented generative language model-based inference system may further include a back-off confidence model 220.

The pre-diagnosis unit 201 includes a diagnosis test set for uncertainty quantification of generative language model or the API 203 and a classifier that classifies user input in accordance with a classification unit on the diagnosis test set.

The pre-diagnosis unit 201 performs classification using a test dataset for distinguishing a vulnerable domain from an overconfident domain, wherein the number of types of domains that are classification targets may be two or more.

The pre-diagnosis unit 201 performs classification using a test dataset designed to identify behavioral differences by task type as to either reasoning or factual queries. Here, the task types fall under a binary classification system divided into two categories.

The distinction between reasoning and factual queries lies in that reasoning is based on premises that are not tied to objective facts, whereas factual queries include questions and answers pertaining to objective facts.

The input configuration unit 200 operates in conjunction with the pre-diagnosis unit 201, and determines input content to be used in querying a generative language model by combining the perturbed results of search results by the knowledge augmentation unit 202.

The output configuration unit 204 uses various output results for the same query that differ in the augmented knowledge, and interacts with the consistency detection unit 210 to combine and output the final response and the confidence thereof.

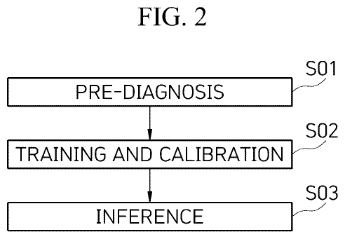

FIG. 2 illustrates an augmented generative language model-based inference method according to an embodiment of the present disclosure.

The augmented generative language model-based inference method according to the embodiment of the present disclosure may include pre-diagnosis step S01, training and calibration step S02, and inference step S03.

### S01: Pre-Diagnosis Step

In the pre-diagnosis step, a diagnosis dataset corresponding to at least one type included in the pre-diagnosis unit 201 is utilized to diagnose the characteristics of the generative language model in advance and to classify the results of diagnosis. The diagnosis dataset is composed of a diagnostic dataset for minimum application domain classification and a diagnostic dataset for task type classification of queries. Since the diagnostic dataset for task type classification is a superset of the diagnostic dataset for domain classification, task type classification and domain classification may be mixed due to the characteristics of how queries are constructed even if diagnostic data has the same query and answer structure.

The diagnostic data includes elements such as knowledge-augmented data (oracle data) including contexts having the correct answer, a knowledge-augmented dataset composed of contexts unrelated to the correct answer, a knowledge-augmented dataset composed of contexts contradicting the correct answer, a query, the correct answer, and type definition metadata (e.g., classification targets such as domain and task type).

According to an embodiment of the present disclosure, although it has been described that the augmented datasets including contexts unrelated to or contradicting the correct answer are added to improve evaluation accuracy, the technical object of the present disclosure may still be achieved even when the augmented dataset is composed only of knowledge-augmented data corresponding to contexts including the correct answer. The reason for this is that, in inference step S03, uncertainty variation caused by the insertion of knowledge-augmented data may be estimated by the input configuration unit 200 and the knowledge augmentation unit 202.

According to an embodiment of the present disclosure, a contradiction group is formed depending on whether knowledge required for deriving the correct answer is extrapolated, and thus uncertainty or variability in the level of confidence that varies with the quality of knowledge reflected in external input is obtained.

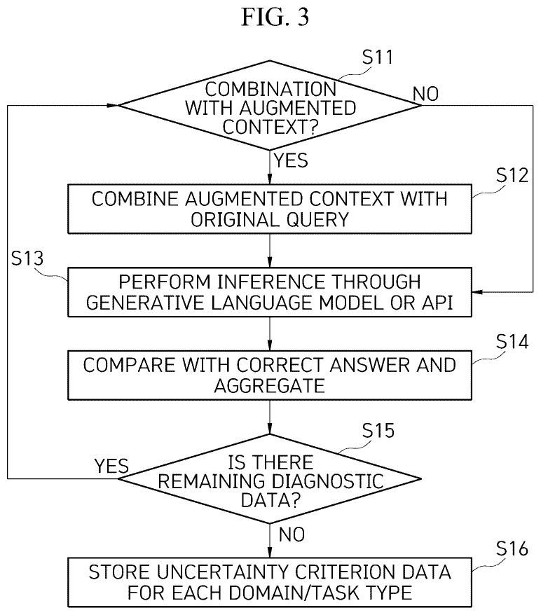

In the pre-diagnosis step, the pre-diagnosis unit 201 performs pre-diagnosis of uncertainty of a generative model, and FIG. 3 illustrates a detailed process of the pre-diagnosis step according to an embodiment of the present disclosure.

In step S11, whether combination with augmented context is to be performed is determined. In step S12, whether knowledge-augmented data influencing derivation of the correct answer is to be combined with a query that basically becomes the target of processing is determined.

According to an embodiment of the present disclosure, step S13 of performing direct inference without combination with knowledge-augmented data is performed at least once, thus deriving the uncertainty of inherent knowledge in the target generative language model.

In step S13, at least two sampled candidates are extracted (wherein it is desired to set the number of candidates to 5 to 10 or more), and in step S14, variability (uncertainty) between the sampled candidates may be aggregated and quantified.

When it is determined in step S11 that combination with augmented context is to be performed, augmented context is combined with an original query in step S12, and the final context to be provided to the generative language model 203 is constructed. This shows that the same process as the process of constructing the final context to be used by the generative language model is performed under interaction between the input configuration unit 200 and the knowledge augmentation unit 202 in step S03 (inference step) of FIG. 2.

As the augmented context, at least one of knowledge-augmented data containing the correct answer, knowledge-augmented data unrelated to the correct answer, or knowledge-augmented data containing content contradicting the correct answer is selected and combined with the original query.

In step S14, correct answer comparison and aggregation are performed, and variability in the difference in actual meaning between the sampled candidates and the correct answer is quantified. In step S14, variability is quantified by using edit distances, such as character-level Jaccard distance that calculates surface-level differences instead of the meanings of output expressions or by using heuristics that combine semantic cluster models, in which similar lexical expressions are clustered, with thesaurus, or by employing Natural Language Inference (NLI) models or Semantic Textual Similarity (STS) models.

The quantification of variability needs to be consistently applied based on a fixed variance scale (e.g., a range from 0 to 1 or from 0 to 100). A quantification means operates in a manner nearly identical to the input-output format and functional configuration of the consistency detection unit 210 in the entire processing structure. Accordingly, the quantification may be processed using the consistency detection unit 210. Conversely, the method used here may be employed as a means for detecting consistency. Therefore, in FIG. 1, it is illustrated that the pre-diagnosis unit 201 and the consistency detection unit 210 interact with each other.

However, in step S03 where the correct answer is not present, the consistency detection unit 210 detects consistency between generated responses, and thus input is configured differently.

In step S15, whether there is diagnostic data which shares the same query that is not yet processed is determined.

When it is determined in step S15 whether there is remaining diagnostic data, the process returns to step S11 where processing on the remaining dataset is performed.

When it is determined in step S15 that there is no remaining diagnostic data, groups sharing the same query are clustered together in step S16, and the average and variance of the uncertainty for each input-result pair and each augmented context are obtained to calculate and store baselines for respective environments so that the baselines are utilized in training and calibration step S02.

### S02: Training and Calibration Step

In the training and calibration step, a prompt template for In-Context Learning (ICL) of the generative language model 203 may be generated to allow the input configuration unit 200 to use the prompt template using calculated information including input-output pairs stored in pre-diagnosis step S01, and more specifically in above-described step S16.

Also, the generative language model 203 is updated so that the generative language model 203 can return its own confidence by itself, or alternatively, a back-off confidence model 220 that provides confidence on behalf of the generative language model 203 is trained and constructed.

The configuration of the In-Context Learning (ICL) prompt template to be delivered to the generative language model 203 is basically mixed with the method obtained in the above-described step S16. The ICL prompt template is generated such that confidence or quantified uncertainty is directly returned to the model.

The prompt template is configured as follows:

```
      <<---- Template Start ---- >>
  Generate a response to the following processing instruction and input query.
However, refer to the input-correct answer-predicted confidence triplet above the
instructions to generate the response, and return confidence for the response, together
with the response, within the section enclosed by <confidence> and </confidence> pair
tags. Between the example and the instructions, {number_of_samples k} pieces of
additional information required to generate the response to the input are provided.
Generate the response with reference to these.
    -Note that the domain of the query corresponds to {query domain}, and the
question type corresponds to {query task type}. The average uncertainty in the {query
domain} is at the level of {uncertainty for each domain}, which corresponds to
{uncertainty criterion explanation}.
  Example 1) Input: {Augmented knowledge of example 1}{Instruction of example
1}{Query of example 1}, Response: {Response to input of example 1}, Confidence:
{Confidence calculated for response to input of example 1}
Example 2) Input: {Another augmented knowledge of example 1}{Instruction of
example 1}{Query of example 1}, Response: {response to another input of example 1},
Confidence: {Confidence calculated for response to another input of example 1}
  Example 3)Input: {Augmented knowledge of example 2}{Instruction of example
2}{Input of example 2}, Response: {Response to input of example 2}, Confidence:
{Confidence calculated for response to input of example 2}
  ...
  Reference Knowledge: {Augmented knowledge candidate 1} {Augmented
knowledge candidate 2}, ..., {Augmented knowledge candidate k}
  Processing instruction: {Query instruction}
  Input: {Query}
  <<---- Template End ---->>
```

A space in the curly brackets ({ }) of the template is treated as a kind of variable, which is filled with a prepared value. When the space is filled with the prepared value, this may be inferred by the generative language model 203.

Here, indication that confidence may vary depending on the reference configuration of augmented knowledge even for the same query may be included in each example.

Further, the criterion information calculated in step S16 may be additionally provided, and may then be referenced when confidence of the response is generated. In addition, the remaining detailed techniques, syntactic configuration, and the like are not especially limited.

In an environment in which access to the weight information of the generative language model 203 is enabled to additionally train the generative language model 203, the generative language model 203 is fine-tuned through a pre-LM training loss function so that the input-output pair derived in the above-described step S16 and the confidence or quantified uncertainty measure in inference step S03 can be returned.

As described above, the input-output pair and confidence stored in step S16 are used without change to generate fine-tuned data.

Assuming that a number of tokens x, each including augmented knowledge, an instruction, and a query, which correspond to the input data, are present at length l, and a number of response tokens y to the input, corresponding to length m, are given, in the case where input X={x₁, . . . , xₗ, y₁, . . . , yₘ} in which the tokens are combined is received, the generative language model 203 is fine-tuned by a model p_{φ} that generates a uncertainty prediction token sequence Y={y₁, . . . , yₜ} a corresponding to the combined input.

$$loss = {min}_{ϕ} - {\sum }_{i = 1}^{m} log {p}_{ϕ} ( Y \vert X )$$

Meanwhile, in order to fine-tune the generative language model 203 using Direct Preference Optimization (DPO), training data is produced using triples composed of (input-desired output-undesired output).

As the desired response data, a response that includes the correct answer and has high confidence is selected, whereas the undesired response data shares the same input conditions, but a response having relatively low confidence is used to construct another candidate response, and a typical DPO training loss function is then applied without change to perform fine-tuning.

Typically, the inference performance of a primitive model may be decreased due to fine tuning. Accordingly, the model, the confidence of which is fine-tuned, according to an embodiment of the present disclosure may be located in the primitive generative language model 203, and may be replaced with the back-off confidence model 220.

Furthermore, in cases where access to weight information is not possible such as in the use of commercial generative language model APIs such as ChatGPT, it is possible to directly predict a uncertainty measure between input and output by combining a generative language model, intended for feature extraction to be capable of fully accessing weights (e.g., open-source generative language models such as LLaMA, OPT, or Polyglot-ko) although it is not identical to the commercial generative language model, with a language understanding model or an understanding generative model for modeling confidence/uncertainty prediction (representatively, one of BERT, BART, or T5). Also, the generated prediction model may then be used as the back-off confidence model 220.

A method of configuring supervised learning data to construct the back-off confidence model 220 in which, among the above-described models, the generative model intended for feature extraction is combined with the model for directly predicting the uncertainty measure using the language understanding model or the understanding generative model, will be described below.

In the diagnosis process, assuming that input delivered to the generative language model 203 is X={x₁, . . . , xₗ}, and a response returned by the generative language model 203 to the input is Y={y₁, . . . , yₘ} and that a value calculated in step S14 of performing confidence and uncertainty quantification through the difference between the response-correct answer is defined as z∈R (where z is a real number-format scalar variable) and a white-box feature including the difference or the like between the result calculated by a function, that is, p_{φ}(X), in which input X is transferred to the generative language model p_{φ} to be used for feature extraction, and the response Y is Φ, the back-off confidence model 220 that directly predicts the uncertainty measure is realized as a regression model p having a parameter set θ that minimizes a Mean Squared Error (MSE) loss function (where N is the number of samples in a supervised learning dataset constructed through the foregoing process).

$$MSE = \frac{1}{N} {\sum }_{i = 1}^{N} ( {z}_{i} - {p}_{ϕ} ( X , Y , Φ ) )$$

In this way, in the training and calibration step, when it is desired to directly perform training, or to perform calibration so that a confidence element can be inferred together with a response through In-Context Learning (ICL), or when there is a difficulty in performing this process or it is desired to improve uncertainty prediction performance, an element required for uncertainty quantification is acquired in inference step S03 through a probability distribution calculated by the back-off confidence model 220.

### S03: Inference Step

In the inference step according to an embodiment of the present disclosure, when an actual user query is received, confidence (quantified uncertainty), along with a suitable response, is returned using the input configuration unit 200, the generative language model 203, and the back-off confidence model 220, which are changed in pre-diagnosis step S01 and training and calibration step S02.

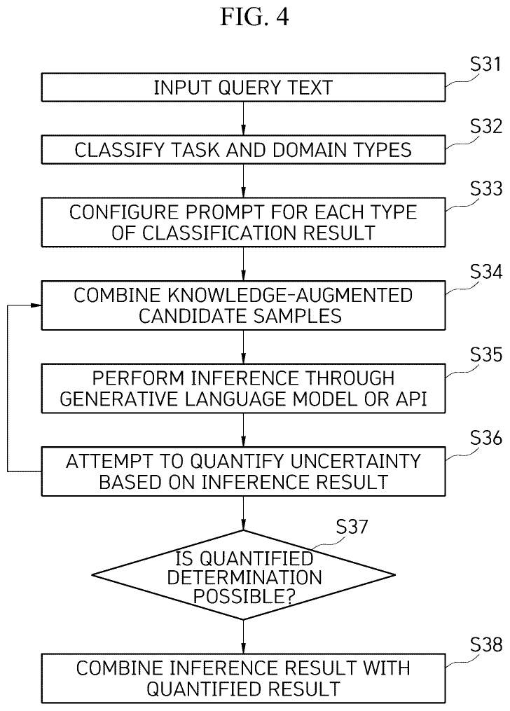

FIG. 4 illustrates the inference step according to an embodiment of the present disclosure.

In step S31, the user inputs a query text into the system. The input query text is delivered to the input configuration unit 200.

In step S32, the input configuration unit 200 uses the domain/query task type classifier of the pre-diagnosis unit 201 to obtain the results of classification of the domain and task types for the user input.

In step S33, the input configuration unit 200 loads a prompt template configured in training and calibration step S02, and fills the template with the classification results and the query. In addition, the input configuration unit 200 acquires augmented knowledge necessary for inferring the query by sending the query and relevant instructions to the knowledge augmentation unit 202.

When there are no results, the knowledge augmentation unit 202 returns information indicative of non-presence of the results. In step S34, when there are results meeting the condition, upper k results may be selected from among the results to fill a reference knowledge field in the prompt template, thus completing the input configuration.

In step S35, the completed input is delivered to the generative language model or API 203 and additionally delivered to the back-off confidence model 220 to perform inference, and generated inference results are delivered to the output configuration unit 204. In this case, when the generative language model 203 calibrated to return confidence is applied, the inference response and additionally generated confidence are separated into designated tag sections (e.g., <confidence></confidence>), and thus the two results are separately stored.

In order for the output configuration unit 204 to return the final response, that is, inference results combined with the confidence (quantified uncertainty), the extent to which the confidence changes depending on the given augmented knowledge needs to be considered together with a confidence factor directly returned by the generative language model 203 or the back-off confidence model 220.

When the output configuration unit 204 according to the embodiment of the present disclosure receives results which do not satisfy the sufficient number of confidence samples required for final decision (in the case of No in step S37) (where the number of samples k=8 is designated and k is determined to be k=(number of candidates returned in step S35, which is a single request processing step, x the number of requests generated by differently combining candidate knowledge+1). The number of requests+1 may be the number of result samples purely generated depending on the inherent knowledge in the generative language model 203 without requiring the knowledge of the knowledge augmentation unit 202. That is, assuming that two candidates are obtained for each request, the number of knowledge-augmented requests is 3, and the number of queries for which knowledge is not augmented is 1, and thus iteration is performed a total of four times), the knowledge augmentation unit 202 re-combines lower-ranked augmented knowledge, which was excluded from inclusion due to ranking, in step S34, and iteratively performs the inference in step S35 and the result acquisition and aggregation process in step S36.

Aggregated output candidate pairs are made by pairing a first query (i.e., the result of inference of knowledge-augmented input matched in the highest rank) and the remaining queries, and are then delivered to the consistency detection unit 210. That is, when k=8, seven pairs are generated and are delivered to the consistency detection unit 210, and thus the quantified differences between the pairs are obtained to calculate the average and variance thereof.

When it is determined in step S37 that quantified determination is possible and calculated configuration is completed, inference results are combined with quantified results to be reconstructed in the form of output, and the output is returned in step S38.

The result of the response to the first query is identified as ‘response’, the value output by the generative language model 203 or the back-off confidence model 220 is identified as ‘response confidence’, a value obtained by the output configuration unit 204 comparing respective candidates and determining consistency is indicated by ‘augmented consistency’, and respectively calculated differences are reconstructed in the form of the following template to complete the final output statement.

```
  <<---- Output Template Start ---->>
  <response>
  {Response}
  </response>
  <confidence>
  The confidence for the above response is {Response Confidence}, and the
influence of the augmented knowledge is evaluated as {Augmented Consistency}. Please
refer to this information when utilizing the result of response for determination.
  </confidence>
  <<---- Output Template End ---->>
```

However, the selection of response results and the configuration of output expression may be modified into a form dependent on the interface, which are not especially limited.

For example, a linear equation (e.g., (response confidence (*coefficient 1)+consistency (*coefficient 2)/(coefficient 1*coefficient 2)) is constructed using the response confidence used in the above-described template and augmented consistency, and thus a single value may be output. For the response result, the final correct answer may be selected in combination with majority voting in consideration of the characteristics of the present disclosure in which multiple candidates are used, rather than configuring a single correct answer based on the inference result from the most appropriate piece of knowledge.

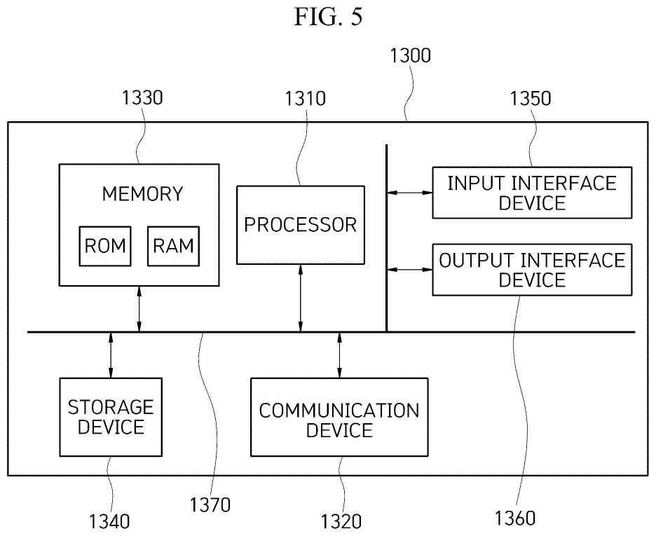

FIG. 5 is a block diagram illustrating a computer system for implementing a method according to an embodiment of the present disclosure.

Referring to FIG. 5, a computer system 1300 may include at least one of a processor 1310, a memory 1330, an input interface device 1350, an output interface device 1360, and a storage device 1340, which communicate with each other through a bus 1370. The computer system 1300 may further include a communication device 1320 connected to a network. The processor 1310 may be a Central Processing Unit (CPU) or a semiconductor device for executing instructions stored in the memory 1330 or the storage device 1340. Each of the memory 1330 and the storage device 1340 may be any of various types of volatile or nonvolatile storage media. For example, the memory 1330 may include a Read-Only Memory (ROM) and a Random Access Memory (RAM). In an embodiment of the disclosure, the memory may be located inside or outside the processor, and may be connected to the processor through various means that are already known. The memory may be any of various types of volatile or nonvolatile storage media, and may include, for example, Read-Only Memory (ROM) or Random Access Memory (RAM).

The augmented generative language model-based inference system according to the embodiment of the present disclosure includes a memory 1350 configured to store a program for performing pre-diagnosis of uncertainty of a generative language model, generating a prompt template to train the generative language model, and returning confidence along with a response when a user query is input using the generative language model, and a processor 1310 configured to execute the program.

The processor 1310 may be configured to diagnose characteristics of the generative language model in advance using a diagnostic dataset and classify results of the diagnosis.

The processor 1310 may be configured to determine whether combination with augmented context is to be performed, determine whether combination with knowledge-augmented data is to be performed, perform inference using the generative language model, perform aggregation and quantification on uncertainty, check whether remaining diagnostic data is present, and calculate uncertainty information for an input-result pair and each augmented context.

The processor 1310 may be configured to, when it is determined that combination with the augmented context is to be performed, combine the augmented context with an original query.

The processor 1310 may be configured to extract sampled candidates and quantify variability in a difference in actual meaning between the sampled candidates and the correct answer.

The processor 1310 may be configured to, when it is determined that remaining diagnostic data is not present, cluster groups sharing an identical query, obtain an average and variance of uncertainty for an input-result pair and each augmented context, and then calculate and store baselines for respective environments.

The processor 1310 may be configured to receive query text of a user, perform domain and task classification for input, complete a template using results of the classification and a query, generate an input configuration, and perform inference using the generative language model and a back-off confidence model.

Therefore, the embodiment of the present disclosure may be implemented either as a method implemented in a computer or as a non-transitory computer-readable medium in which computer-executable instructions are stored. In an embodiment, when executed by the processor, the computer-readable instructions may perform a method according to at least one aspect of the present disclosure.

The communication device 1320 may transmit or receive a wired signal or a wireless signal.

Furthermore, the method according to an embodiment of the present disclosure may be implemented in the form of program instructions executable through various types of computer means, and may be recorded on a computer-readable medium.

The computer-readable medium may include program instructions, data files, data structures, or the like, either alone or in combination. The program instructions recorded on the computer-readable medium may be specially designed and configured for implementing the present disclosure, or may be known and available to those skilled in the field of computer software. A computer-readable recording medium may include hardware devices configured to store and execute program instructions. For example, the computer-readable recording medium may include magnetic media such as a hard disk, a floppy disk, and magnetic tape, optical media such as CD-ROMs and DVDs, magneto-optical media such as a floptical disk, ROM, RAM, and flash memory. The program instructions may include not only machine code, such as code produced by a compiler, but also high-level language code that can be executed by a computer using an interpreter or the like.

While the embodiments of the present disclosure have been described in detail above, it should be understood that the scope of the present disclosure is not limited thereto. Various modifications and alterations made by those skilled in the art, based on the basic concept of the disclosure defined in the accompanying claims, may also fall within the scope of the present disclosure.

What is claimed is:

1. An augmented generative language model-based inference method performed by an augmented generative language model-based inference system, the augmented generative language model-based inference method comprising:
(a) performing pre-diagnosis of uncertainty of a generative language model;
(b) generating a prompt template to train the generative language model; and
(c) performing inference of returning confidence along with a response when a user query is input using the generative language model.

2. The augmented generative language model-based inference method as claimed in claim 1, wherein (a) comprises:
diagnosing characteristics of the generative language model in advance using a diagnostic dataset, and classifying results of diagnosis.

3. The augmented generative language model-based inference method as claimed in claim 2, wherein the diagnostic dataset includes diagnosis datasets for application domain classification and for query task type classification.

4. The augmented generative language model-based inference method as claimed in claim 3, wherein diagnostic data in the diagnostic dataset includes knowledge-augmented data including context having a correct answer, knowledge-augmented data composed of contexts unrelated to the correct answer, knowledge-augmented data composed of contexts contradicting the correct answer, a query, the correct answer, and type definition metadata.

5. The augmented generative language model-based inference method as claimed in claim 1, wherein (a) comprises:
(a-1) determining whether combination with augmented context is to be performed;
(a-2) determining whether combination with knowledge-augmented data is to be performed;
(a-3) performing inference using the generative language model;
(a-4) performing aggregation and quantification on uncertainty;
(a-5) checking whether remaining diagnostic data is present; and
(a-6) calculating uncertainty information for an input-result pair and each augmented context.

6. The augmented generative language model-based inference method as claimed in claim 5, wherein, when it is determined in (a-1) that combination with the augmented context is to be performed, the augmented context is combined with an original query in (a-2).

7. The augmented generative language model-based inference method as claimed in claim 5, wherein (a-3) comprises extracting sampled candidates.

8. The augmented generative language model-based inference method as claimed in claim 5, wherein (a-4) comprises:
quantifying variability in a difference in actual meaning between sampled candidates and the correct answer.

9. The augmented generative language model-based inference method as claimed in claim 5, further comprising:
when it is determined in (a-5) that remaining diagnostic data is present, returning to (a-1) of performing processing on a remaining dataset.

10. The augmented generative language model-based inference method as claimed in claim 5, wherein when it is determined in (a-5) that remaining diagnostic data is not present, (a-6) comprises:
clustering groups sharing an identical query, obtaining an average and variance of uncertainty for an input-result pair and each augmented context, and then calculating and storing baselines for respective environments.

11. The augmented generative language model-based inference method as claimed in claim 1, wherein (b) comprises:
performing fine-tuning on the generative language model in an environment in which access to weight information of the generative language model is enabled to allow additional training.

12. The augmented generative language model-based inference method as claimed in claim 1, wherein (c) comprises:
(c-1) receiving query text of a user;
(c-2) performing domain and task classification for input;
(c-3) completing a template using results of the classification and a query;
(c-4) generating an input configuration; and
(c-5) performing inference using the generative language model and a back-off confidence model.

13. An augmented generative language model-based inference system, comprising:
a memory configured to store a program for performing pre-diagnosis of uncertainty of a generative language model, generating a prompt template to train the generative language model, and returning confidence along with a response when a user query is input using the generative language model; and
a processor configured to execute the program.

14. The augmented generative language model-based inference system as claimed in claim 13, wherein the processor is configured to diagnose characteristics of the generative language model in advance using a diagnostic dataset and classify results of the diagnosis.

15. The augmented generative language model-based inference system as claimed in claim 13, wherein the processor is configured to determine whether combination with augmented context is to be performed, determine whether combination with knowledge-augmented data is to be performed, perform inference using the generative language model, perform aggregation and quantification on uncertainty, check whether remaining diagnostic data is present, and calculate uncertainty information for an input-result pair and each augmented context.

16. The augmented generative language model-based inference system as claimed in claim 15, wherein the processor is configured to, when it is determined that combination with the augmented context is to be performed, combine the augmented context with an original query.

17. The augmented generative language model-based inference system as claimed in claim 15, wherein the processor is configured to extract sampled candidates and quantify variability in a difference in actual meaning between the sampled candidates and the correct answer.

18. The augmented generative language model-based inference system as claimed in claim 15, wherein the processor is configured to, when it is determined that remaining diagnostic data is not present, cluster groups sharing an identical query, obtain an average and variance of uncertainty for an input-result pair and each augmented context, and then calculate and store baselines for respective environments.

19. The augmented generative language model-based inference system as claimed in claim 15, wherein the processor is configured to receive query text of a user, perform domain and task classification for input, complete a template using results of the classification and a query, generate an input configuration, and perform inference using the generative language model and a back-off confidence model.
